(19) United States
(12) Patent Application Publication
(10) Pub. No.: US 2008/0179918 A1
(43) Pub. Date: Jul. 31, 2008

(54) Wiperles windshield clearing system

(76) Inventors: John Yuming Liu, Fresh Meadows, NY (US); Vincent S. Tong, Rego Park, NY (US)

Correspondence Address: JOHN YUMING LIU, 69-57, 180 St., FRESH MEADOWS, NY, 11365, US

(21) Appl. No.: 11/699,528

(22) Filed: Jan. 30, 2007

(51) Int. Cl. B60R 27/00

(52) U.S. Cl. 296/200

(57) ABSTRACT

This invention is to replace any mechanical wind wiper for a vehicle operation. We construct the air pump to blow the air to push the debris, rain water, and snow away from the windows. The pneumatic windshield clearing system includes an air source from engine assembly or and muffler coupled with vehicle, a metal pipes with small holes to have the high pressure pushed air from the top, bottom and side of windshield toward the surface of the windshield.

### REFERENCES

Provisional application U.S. Pat. No. 7,080,872 B1 files on Jul. 25, 2006

This invention is related with pneumatic windshield clearing system. We have to construct the air blower, metal or plastic pipes with outlet and the air source from the engine housing, or and muffler. Those will replace the types of windshield wiper and debris clearing systems.

As best illustrated in FIGS. 1 through 3, the pneumatic windshield clearing system comprises a blower assembly, suction assembly and air source assembly.

The blower assembly is preferably located next to the engine beneath the hood of the vehicle. The blower has connected to the air pipes (metal or plastic) with outlet which is mounted along the top, bottom and side of the windows for forcing rain, snow, and other debris off of the windshield.

The blower assembly is operationally coupled with the air source assembly. We also keep the fluid nozzle to clean the window. Air pipes has many outlets along the edges of the windshield.

The suction assembly may be operationally coupled with the air source assembly. The suction assembly should suck the air from the engine or and from muffler or mixed. The air source assembly will provide the high pressure air to the blower assembly.

In use, this system is activated whenever rain, snow, or other debris is blown off the windshield.

The blow assembly forces any other material off the windshield, and clean the windshield without the need for wipes.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF THE DRAWINGS

FIG. 1 is a schematic perspective view of a new pneumatic windshield clearing system according to the present invention

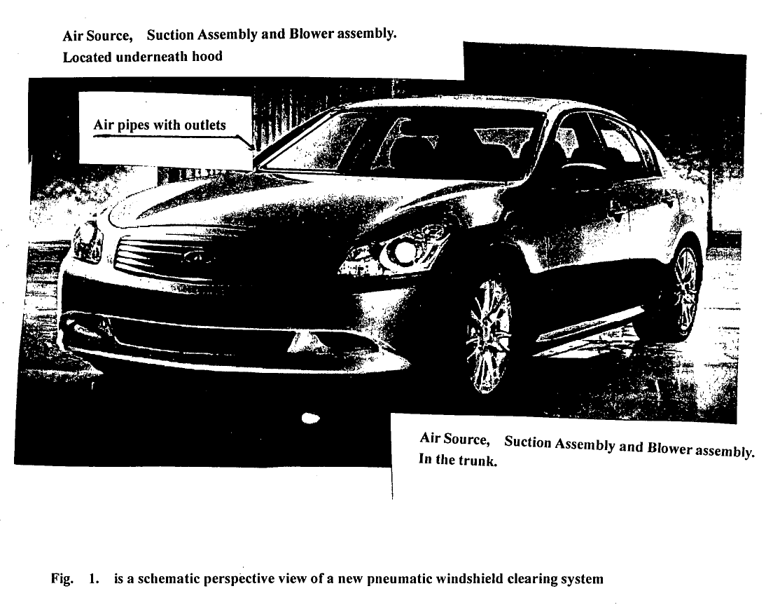

FIG. 2 is a schematic rear view of the present invention

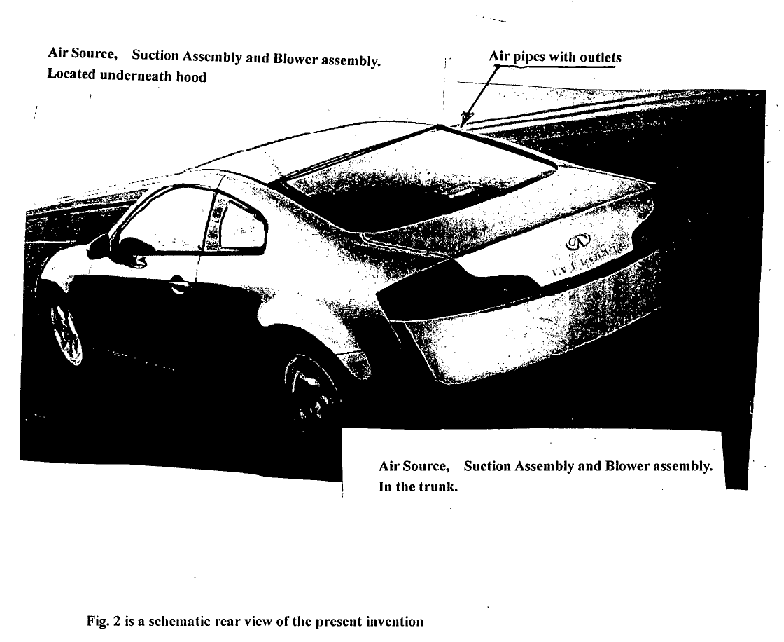

FIG. 3 is a schematic functional relation of the present invention.

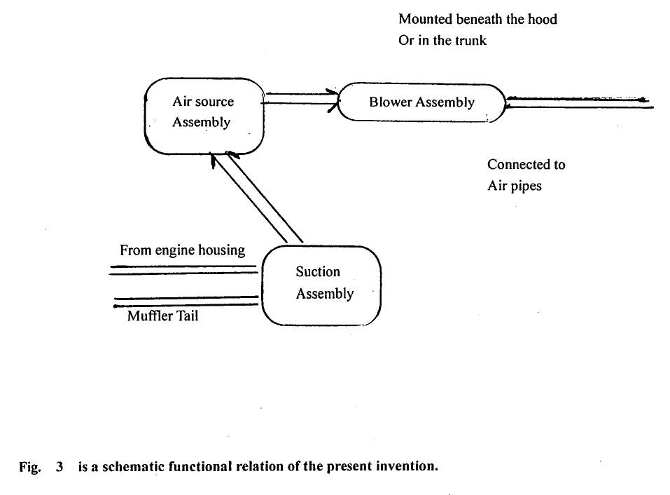

The invention of the claimed are:

1. metal or plastic pipes with outlet which can be mounted along the windows.

2. Air pump with air source from engine area or and from air muffler.
